(19) United States
(12) Patent Application Publication
(10) Pub. No.: US 2025/0357703 A1
(43) Pub. Date: Nov. 20, 2025

(54) DATA CONNECTOR ASSEMBLY

(71) Applicant: Microsoft Technology Licensing, LLC, Redmond, WA (US)

(72) Inventors: Brett Andrew TOMKY, Seattle, WA (US); Devin Samuel Jacob CAPLOW-MUNRO, Seattle, WA (US)

(73) Assignee: Microsoft Technology Licensing, LLC, Redmond, WA (US)

(21) Appl. No.: 18/667,672

(22) Filed: May 17, 2024

(51) Int. Cl. H01R 13/639; H01R 13/514; H01R 13/62; H01R 13/627; H01R 13/652

(52) U.S. Cl. CPC H01R 13/639; H01R 13/514; H01R 13/6205; H01R 13/6273; H01R 13/652

(57) ABSTRACT

In an example, a data connector plug includes a connector plug shell sized and shaped for insertion into a complementary data connector receptacle of an electronic device. A ground spring is disposed within the connector plug shell. The ground spring has a U-shaped profile at a distal end of the ground spring, wherein the U-shaped profile includes a first ridge and a second ridge, and wherein a reference line passing between the first ridge and the second ridge is parallel to an insertion direction of the data connector plug into the data connector receptacle.

### BACKGROUND

Universal Serial Bus type C (USB-C) connectors are growing in popularity as data and/or power delivery interfaces for electronic devices. Typically, a USB-C plug includes two internal ground springs that, when inserted into a USB-C receptacle, interact with a tab within the USB-C receptacle to cause a retention force that holds the plug in place.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

In an example, a data connector plug includes a connector plug shell sized and shaped for insertion into a complementary data connector receptacle of an electronic device. A ground spring is disposed within the connector plug shell. The ground spring has a U-shaped profile at a distal end of the ground spring, wherein the U-shaped profile includes a first ridge and a second ridge, and wherein a reference line passing between the first ridge and the second ridge is parallel to an insertion direction of the data connector plug into the data connector receptacle.

### BRIEF DESCRIPTION OF THE DRAWINGS

FIG. 1 schematically depicts an example data connector plug and an example data connector receptacle of an electronic device.

FIGS. 2A-2C schematically illustrate interaction between ground springs of a data connector plug and retention ramps of a receptacle tab of a data connector receptacle.

FIGS. 3A and 3B show different views of an example data connector plug.

FIGS. 4A, 4B, and 4C show different views of an example ground spring of a data connector plug.

FIGS. 5A, 5B, and 5C show different views of an example receptacle-side data connector assembly.

FIGS. 6A, 6B, and 6C show aspects of a Universal Serial Bus type C (USB-C) data connector assembly.

FIGS. 7A-7D schematically depict interaction between ground springs and receptacle tabs in different data connector configurations.

### DETAILED DESCRIPTION

The present disclosure is directed to modified structural designs for data connectors, including male data connector plugs and female data connector receptacles. The designs described herein preserve compatibility with standard Universal Serial Bus type C (USB-C) devices, while changing the manner in which the data connector plug is retained within the connector receptacle.

As discussed above, USB-C data plugs include internal ground springs. These are used to establish an electrical ground connection between the data plug and an electronic device into which the plug is inserted. Additionally, standard USB-C data connector receptacles include a receptacle tab having two lateral retention ramps. Contact between the ground springs and the lateral retention ramps of the receptacle tab causes the ground springs to bow outwards during insertion or removal of the plug. This causes a retention force that both resists insertion of the connector plug into the connector receptacle, and also resists removal of the connector plug from the connector receptacle after insertion.

However, in some scenarios, it may be desirable to include additional or alternative elements in the data connector assembly that serve to hold the data connector plug in place within the data connector receptacle. For instance, in some examples described below, the data connector plug, and the electronic device into which it is inserted, include complementary magnets that magnetically retain the data connector plug within the data connector receptacle. However, as discussed above, interaction between the ground springs of the connector plug and the lateral retention ramps of the receptacle tab resists insertion of the connector plug into the connector receptacle. In order to overcome this resistance, it may be necessary to include relatively large and powerful magnets, which can make the overall design cumbersome or infeasible.

Accordingly, the present disclosure describes modified structures that may be used for ground springs of a USB-C compatible data connector plug, and for the receptacle tabs of a USB-C compatible data connector receptacle. When the herein-described modified data connector plug is inserted into a modified data connector receptacle, the amount of retention force caused by interaction between the ground springs and the retention tab is reduced as compared to standard USB-C components. In some examples, the modified ground springs and retention tab provide no significant retention force at all, which enables the use of other elements (such as magnets) to hold the data connector plug in place.

Notably, however, these modified designs preserve compatibility with standard USB-C components. For instance, when the modified data connector plug is inserted into a standard USB-C data connector receptacle, the ground springs still provide a relatively standard retention force when interacting with the receptacle tab. Similarly, when a standard USB-C data connector plug is inserted into a modified data connector receptable, the ground springs and retention tab once again provide a relatively standard retention force. This beneficially provides an enhanced experience when the modified designs are used together (e.g., using magnets to provide an enhanced user experience during plug insertion), without compromising compatibility with existing USB-C devices.

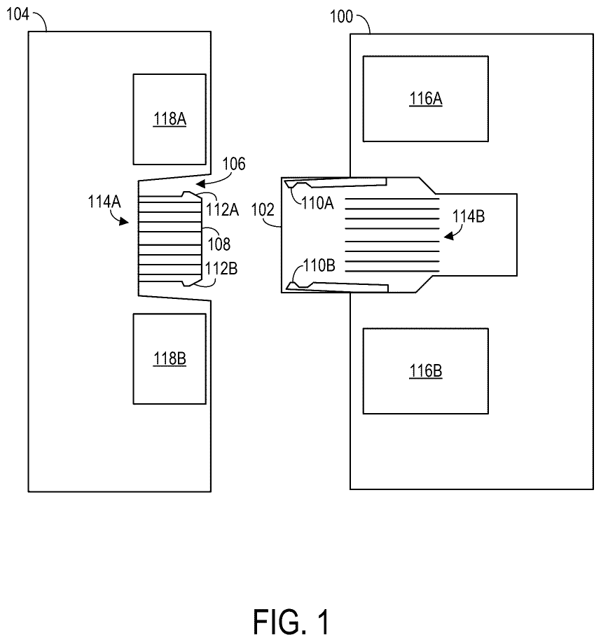

FIG. 1 schematically shows an example data connector plug assembly 100. As shown, the data connector plug includes a connector plug shell 102, which is sized and shaped for insertion into a complementary data connector receptacle of an electronic device. In FIG. 1, an example electronic device 104 includes a data connector receptacle 106. By inserting the data connector plug into the data connector receptacle, data and/or power connectivity with the electronic device may be established.

In one non-limiting example, the electronic device 104 is a computing device, such as a smartphone or laptop, and the data connector plug assembly is used to establish connectivity between the electronic device and a charging and/or data communication cable. However, it will be understood that USB-C compatible data connectors may be used in a wide variety of different electronic devices. These may include computing devices such as laptops, desktops, servers, smartphones, tablets, display devices such as monitors, televisions, projectors, input devices such as mice, keyboards, microphones, cameras, and/or any of a wide variety of other suitable types of electronic devices. It will be understood that the structures described in the present disclosure may be applied to data connectors in general, regardless of the shape, size, and capabilities of the electronic device(s) into which they are incorporated. Furthermore, while components described herein are generally referred to as “data connectors,” it will be understood that the structures described herein may in some cases be used for power transmission in addition to, or instead of, facilitating data communication.

In FIG. 1, the data connector receptacle includes a receptacle tab 108. The data connector plug includes two ground springs 110A and 110B, disposed within the connector plug shell 102. The connector plug shell is sized and shaped to enclose the receptacle tab 108 of the data connector receptacle when the connector plug shell is inserted into the receptacle. This brings the ground springs 110A and 110B into close proximity with lateral retention ramps 112A and 112B of the receptacle tab. Additional details regarding the ground springs and lateral retention ramps will be provided below. The present disclosure generally focuses on scenarios where two ground springs and two corresponding lateral retention ramps are used, although it will be understood that this is non-limiting, and that any suitable number of ground springs and retention ramps may be used.

Additionally, in this example, the electronic device includes a plurality of receptacle-type connector contacts 114A disposed within the data connector receptacle—e.g., integrated into the receptacle tab 108. These are sized and shaped to interface with a corresponding plurality of plug-type connector contacts 114B of the data connector plug 100. In other words, the receptacle-type and plug-type electrical contacts are complementary to one another, such that insertion of the data connector plug creates an electrical interface between the data connector plug assembly and the electronic device. The receptacle-type and plug-type electrical contacts may take any suitable form provided they retain compatibility with USB-C devices. For instance, the receptacle-type electrical contacts may be compatible both with plug-type electrical contacts of modified data connector plugs that will be described in more detail below, along with plug-type electrical contacts of standard USB-C data connector plugs.

Furthermore, in the example of FIG. 1, the data connector plug assembly includes a plug-side retention magnet 116A. In this example, the data connector plug additionally includes a second plug-side retention magnet 116B. These are positioned such that, during insertion of the data connector plug into the data connector receptacle, the plug-side retention magnets are magnetically attracted to corresponding receptacle-side retention magnets 118A and 118B to cause a magnetic retention force that resists removal of the data connector plug from the data connector receptacle. Use of magnets for data connector retention can improve the user experience when inserting or removing the data connector plug from the connector receptacle. For instance, magnetic attraction may facilitate an easier and more satisfying insertion process for the user—e.g., reducing the amount of time the user spends aligning the plug with the receptacle, and reducing the amount of force that is required for the user to supply during insertion. This beneficially improves the user experience—e.g., improves interaction between the user and the computing device—while still resisting removal of the data connector plug from the receptacle. It will be understood that the data connector plug assembly and the electronic device may have any suitable number of complementary magnets for retaining the data connector plug. The size, positioning, and magnetic strength of these magnets may vary depending on the implementation—e.g., depending on the desired amount of retention force and physical space requirements within each device housing.

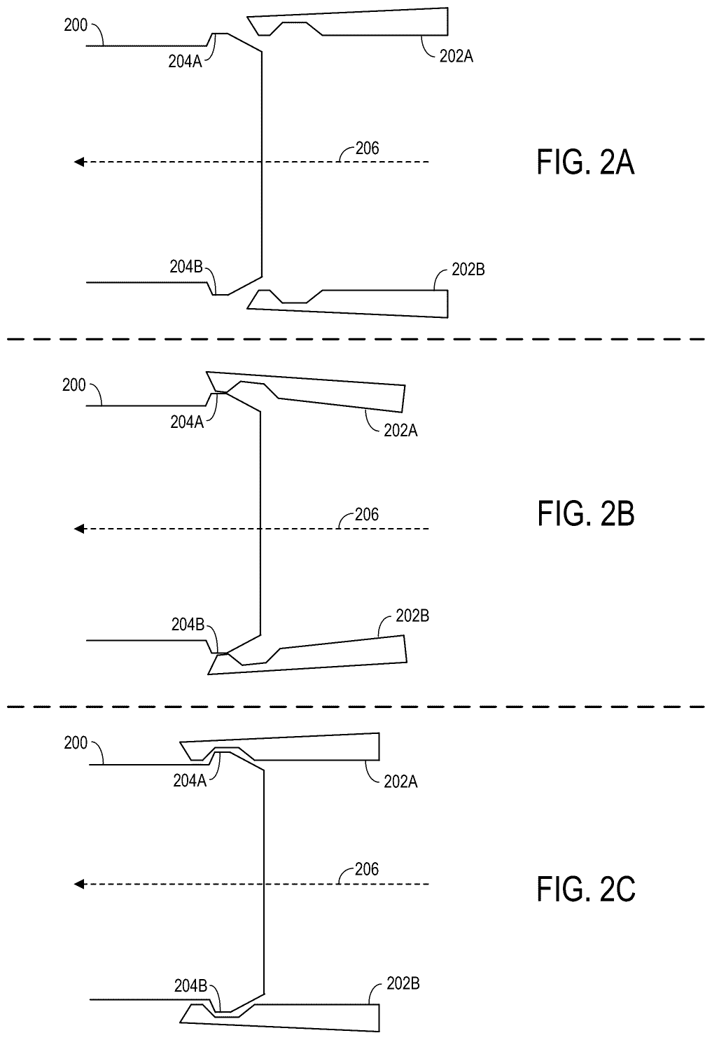

FIGS. 2A-2C schematically illustrate interaction between ground springs and lateral retention ramps in standard USB-C data connector configurations. It will be understood that FIGS. 2A-2C are highly simplified for the sake of explanation. As shown, in FIG. 2A, a receptacle tab is positioned near ground springs 202A and 202B. The ground springs are components of a data connector plug that is being inserted into a data connector receptacle, within which the receptacle tab 200 is positioned. For visual clarity, other components of the data connector plug and data connector receptacle are omitted. In other words, the data connector plug is being inserted into the data connector receptacle along an insertion direction 206, such that the ground springs are being moved toward lateral retention ramps 204A and 204B of the receptacle tab.

In the example of FIG. 2B, continued insertion of the data connector plug has caused the ground springs to contact the lateral retention ramps. This displaces the ground springs—e.g., causing lateral deflection of the ground springs away from the lateral retention ramps. In the simplified example of FIGS. 2A-C, as well as other figures herein depicting insertion of data connector plugs, the ground springs are depicted as pivoting away from a rest position when contacting the lateral retention ramps. It will be understood that this is non-limiting, and that spring force may additionally or alternatively be caused by bending of the ground springs rather than pivoting of the ground springs. The present disclosure describes movement of the ground springs that causes spring retention force as “deflection” of the ground springs due to contact with lateral retention ramps, regardless of whether such force is caused by pivoting, bending, and/or other suitable movements of the ground springs.

In any case, this displacement of the ground springs provides a spring force that attempts to return the ground springs to their resting orientation depicted in FIG. 2A. In other words, in this example, insertion of the data connector plug requires an insertion force sufficient to overcome the spring force provided by the ground springs. The spring force may have any suitable magnitude, depending on the properties of the ground springs (e.g., their resistance to pivoting or bending), the geometry of the ground springs, and the geometry of the retention ramps. In some examples, the spring force may be on the order of single newtons or tens of newtons.

FIG. 2C depicts a scenario where continued insertion of the data connector plug has moved the distal ends of the ground springs beyond the lateral retention ramps. In other words, the insertion force was sufficient to overcome the spring force, resulting in successful insertion of the data connector plug into the data connector receptacle. From this configuration, the respective geometries of the ground springs and the lateral retention tabs resist removal of the data connector plug from the data connector receptacle. In other words, an attempt to remove the data connector plug will cause the ground springs to again contact the lateral retention ramps, resulting in deflection of the ground springs. This deflection will cause a spring retention force that resists removal of the data connector plug from the data connector receptacle. Again, this retention force may have any suitable value depending on the implementation—e.g., on the order of single newtons or tens of newtons. As one non-limiting example, the spring retention force resisting removal of the data connector plug may be greater than five newtons. This level of retention force can beneficially reduce the risk of unintentional removal of the data connector plug from the data connector receptacle, which improves human-computer interaction.

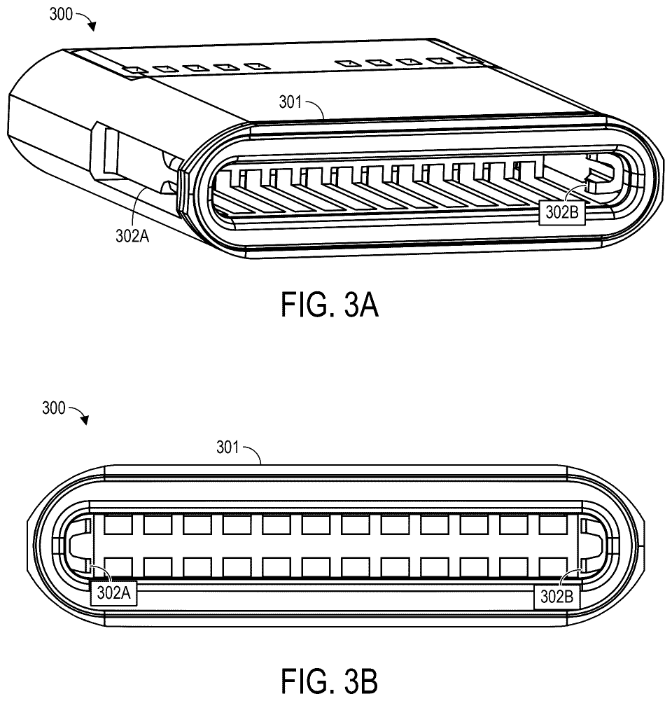

As discussed above, modifications to the ground springs and/or the lateral retention ramps may affect the interactions between the ground springs and lateral insertion ramps during data connector plug insertion, thereby altering the retention force. FIGS. 3A and 3B depict aspects of an example data connector plug design having modified ground springs as compared to standard USB-C data connector plugs. Specifically, FIGS. 3A and 3B provide different views of an example data connector plug 300. The data connector plug includes a connector plug shell 301 sized and shaped for insertion into a complementary data connector receptacle, as discussed above.

In this example, the data connector plug includes two ground springs 302A and 302B. However, unlike ground springs of standard USB-C data connector plugs, ground springs 302A and 302B have U-shaped profiles at the distal ends of the ground springs. As will be described in more detail below, the U-shaped profile of each ground spring includes a first ridge and a second ridge (e.g., the “arms” of the U-shape), such that a reference line passing between the first ridge and the second ridge is parallel to an insertion direction of the data connector plug into the data connector receptacle. It will be understood that a “U-shaped profile” may refer to a range of suitable profile geometries and need not be limited only to shapes that exactly resemble the letter U. Rather, a “U-shaped profile” generally refers to a suitable curving or arcing structure including a central portion and two ridges bending or curving away from the central portion. The central portion and two ridges define a gap that other objects of sufficient size can fit within. These ridges may be substantially parallel to one another for at least a portion of their length (e.g., as is the case in the letter U), although this is non-limiting. For instance, in some examples, the angles of the ridges may be such that they extend away from each other along their length, or extend toward each other along their length.

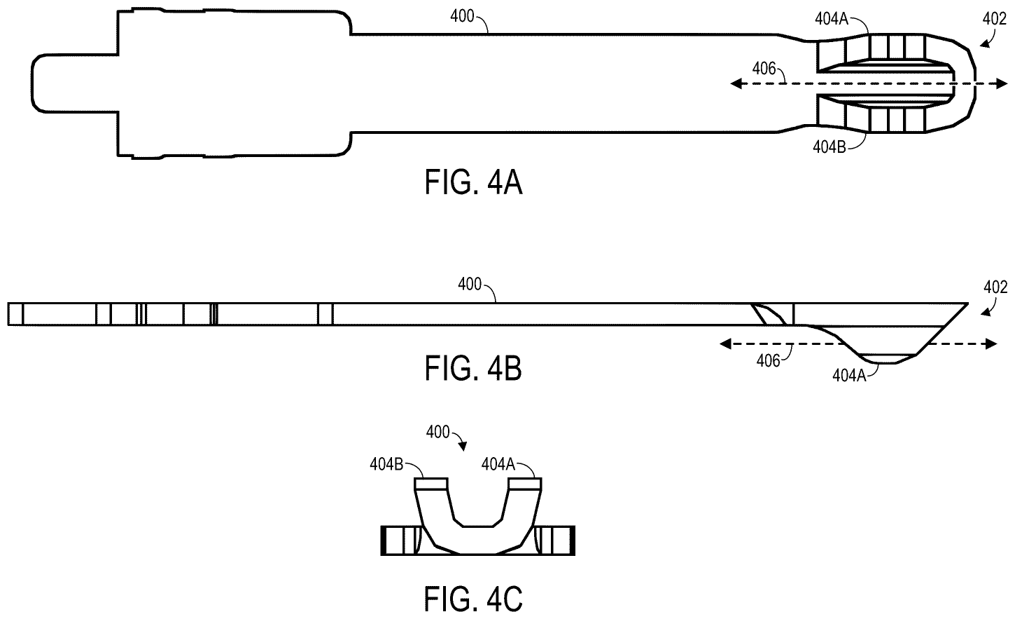

This is illustrated with respect to FIGS. 4A, 4B, and 4C. Specifically, FIGS. 4A-4C provide different views of an example ground spring 400 having a modified structure as compared to standard USB-C components. As discussed above, the distal end 402 of the ground spring has a U-shaped profile, including a first ridge 404A and a second ridge 404B. The two ridges are spaced apart, such that a reference line 406 passing between the two ridges of the U-shaped profile does not intersect the ground spring. The reference line is parallel to the insertion direction of the data connector plug. It will be understood that a reference line passing between the ridges of the U-shaped profile need not be exactly parallel to the insertion direction. Rather, depending on the implementation and the specific geometries of the data connector plug and receptacle, the reference line may be substantially parallel to (e.g., within five degrees of) an insertion axis along which the data connector plug is inserted. As will be described in more detail below, this may enable a modified lateral retention ramp having a narrower ramp width to pass between the two ridges of the U-shaped profile, thus enabling the ground spring to pass over the lateral retention ramp without laterally deflecting.

Notably, however, the width of the gap between the two ridges of the U-shape profile may not be sufficient to accommodate a lateral retention ramp of a standard USB-C data connector receptacle, having a standard width. Instead of passing through the gap between the two ridges, a lateral retention ramp of standard width may instead contact the curved profile of the two ridges (e.g., ridge 404A has a curved profile as shown in FIG. 4B), causing deflection of the ground spring in a similar manner to what would be observed with standard USB-C ground springs. In this manner, the modified ground spring 400 preserves compatibility with standard USB-C data connector receptacles.

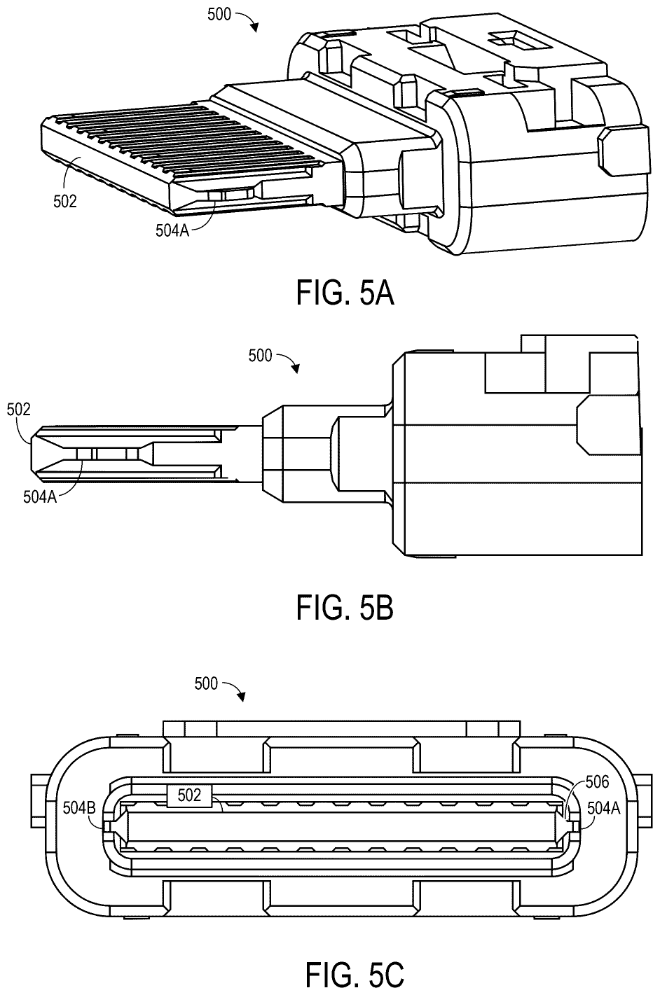

FIGS. 5A, 5B, and 5C provide different views of an example data connector receptacle assembly 500 having a modified structure as compared to standard USB-C data connector receptacles. Specifically, as shown, the data connector receptacle assembly includes a receptacle tab 502. As discussed above, the receptacle tab is sized and shaped such that, after insertion of a data connector plug into the connector receptacle, the receptacle tab is enclosed by the connector plug shell of the data connector plug. During insertion, ground springs of the data connector plug come into close proximity with lateral retention ramps 504A and 504B of the receptacle tab.

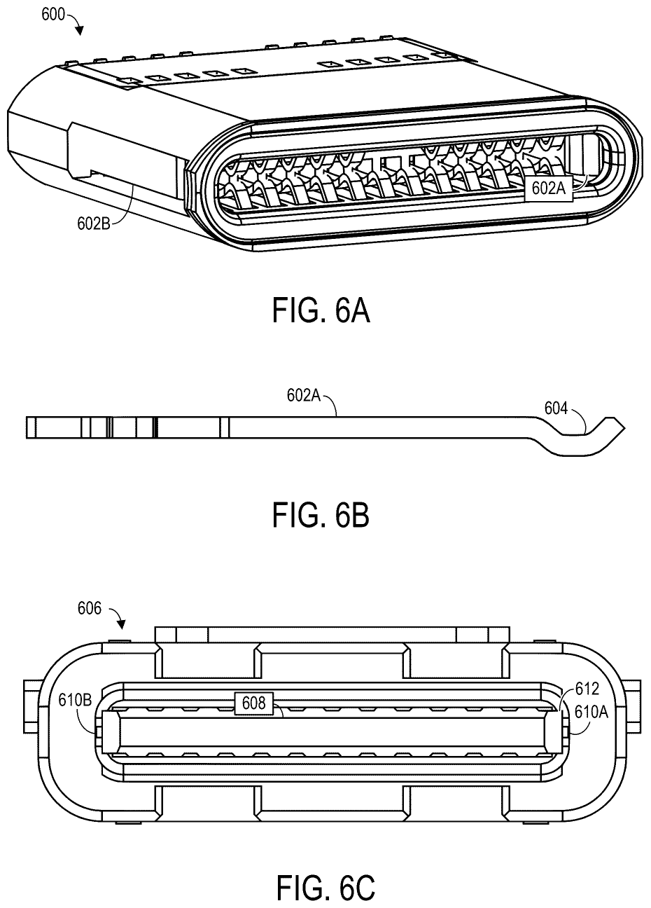

With reference to FIG. 5C, it can be seen that the rectangular body of the receptacle tab narrows at its lateral edges toward the retention ramps 504A and 504B. See, for instance, slanted edge 506, where the rectangular body of the receptacle tab narrows toward the tip of retention ramp 504A. This narrowing at the edges of the receptacle tab differs from standard USB-C receptacle tabs, as will be described below with respect to FIG. 6C. Specifically, each modified lateral retention ramp 504A and 504B has a narrower ramp width as compared to a standard USB-C data connector receptacle.

As discussed above, this narrower ramp width may be sufficiently small for the lateral retention ramp to pass between two ridges of a U-shaped profile of a modified ground spring, as a modified data connector plug is inserted into the modified data connector receptacle. In other words, the lateral retention ramp may pass between the first ridge and the second ridge of the U-shaped profile of the ground spring during insertion of the data connector plug into the data connector receptacle. This reduces, or effectively eliminates, the retention force normally caused by interaction between the ground springs and receptacle tabs of USB-C data connectors. For instance, any interaction between the ground springs and the receptacle tabs may result in an incidental spring retention force of less than one newton. This beneficially enables use of other structures (e.g., retention magnets) to facilitate insertion of the data connector plug, and resist removal of the data connector plug, which can improve the user experience as discussed above. However, the modified data connector receptacle structures depicted in FIGS. 5A-C preserve compatibility with standard USB-C data connector plugs, which have a different shape at their distal ends as compared to the modified data connector plugs described herein, as will be described with respect to FIGS. 6A and 6B. This difference in shape causes the standard ground springs to contact the lateral retention ramps of the modified receptacle tab, thereby still causing lateral deflection of the ground springs and producing a retention force.

FIGS. 6A-C show different components of standard USB-C data connectors, to illustrate differences as compared to the modified structures shown in FIGS. 3A-5C. Specifically, FIG. 6A shows a view of a standard USB-C data connector plug, having a connector plug shell 601 and ground springs 602A and 602B. FIG. 6B shows a more detailed side profile of ground spring 602A.

As shown in FIGS. 6A and 6B, ground spring 602A lacks the U-shaped profile of ground springs 302B and 400—e.g., it does not include two ridges spaced apart such that a reference line extending parallel to the direction of insertion passes between the two ridges. In other words, the ground spring lacks a U-shaped channel for the retention ramp to pass through during insertion of a data connector plug. Thus, regardless of whether ground spring 602A is used with a standard receptacle tab or a modified receptacle tab having narrower retention ramps, the ground spring will be laterally deflected by the retention ramp during insertion, causing a retention force. For instance, if multiple cross sections of the distal end 604 of ground spring 602A were taken at different depths, each cross section would have a substantially similar profile regardless of its depth. By contrast, ground spring 400 of FIG. 4B would have different profiles at different cross-sectional depths, as ground spring 400 includes two ridges 404A and 404B spaced apart.

FIG. 6C shows a view of a standard USB-C data connector receptacle assembly 606. This includes a standard receptacle tab 608, with lateral retention ramps 610A and 610B. In contrast to the receptacle tab shown in FIGS. 5A-C, the rectangular body of the receptacle tab has squared corners in the vicinity of the lateral retention ramps. For instance, squared corner 612 has a different shape from slanted edge 506 shown in FIG. 5C. As such, both of standard USB-C ground spring 602A and modified ground spring 400 would contact the lateral retention ramp, and be laterally deflected by the lateral retention ramp, during insertion of a data connector plug into a data connector receptacle.

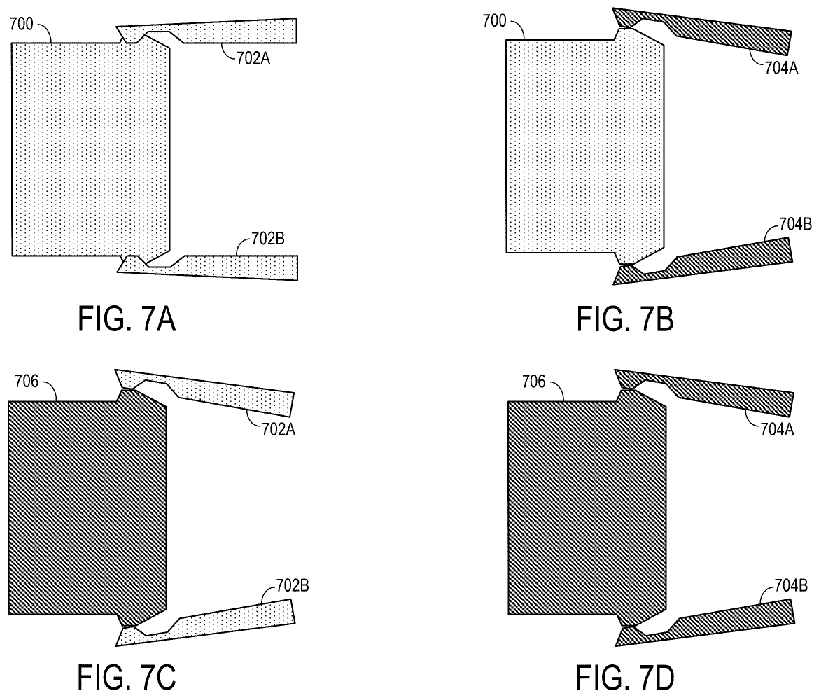

Various different insertion scenarios are schematically illustrated with respect to FIGS. 7A-7D. FIG. 7A schematically depicts a scenario where a modified receptacle tab 700 (e.g., similar to receptacle tab 502) is used with modified ground springs 702A and 702B (e.g., having U-shaped profiles similar to ground spring 400). As discussed above, the narrower retention ramps of the modified receptacle tabs pass between the ridges of the U-shaped profiles of the modified ground springs. As such, the ground springs are not laterally deflected by the retention ramps, resulting in less retention force. In some examples, any incidental interaction between the modified ground springs and the modified receptacle tabs is less than one newton. In some examples, such interaction produces substantially no appreciable retention force at all, and other components (such as magnets) are used to retain the data connector plug within the data connector receptacle.

FIG. 7B shows another scenario, where modified receptacle tab 700 is used with standard USB-C ground springs 704A and 704B—e.g., during insertion of a standard USB-C data connector plug into the modified data connector receptacle. As shown, this results in contact between the standard ground springs and the modified lateral retention ramps, causing a spring retention force that resists insertion and removal of the data connector plug. As discussed above, this is caused by lateral deflection of the standard ground springs due to contact between the lateral retention ramps and the surfaces of the standard ground springs. Furthermore, as discussed above, the spring retention force may have any suitable value. For instance, it may be on the order of single newtons or tens of newtons. As one example, the spring retention force may be greater than five newtons.

FIG. 7C shows another scenario, where modified ground springs 702A and 702B are used with a standard USB-C retention tab 706. As discussed above, while the modified ground springs do have U-shaped profiles, including two ridges spaced apart, the lateral retention ramps of the standard receptacle tab are not sufficiently narrow to pass between the two ridges. As such, the ground springs are laterally deflected by the retention ramps. FIG. 7D shows a scenario where the standard USB-C ground springs are used with the standard USB-C receptacle tab, in which the ground springs are again laterally deflected.

In an example, a data connector plug comprises: a connector plug shell sized and shaped for insertion into a complementary data connector receptacle of an electronic device; and a ground spring disposed within the connector plug shell, the ground spring having a U-shaped profile at a distal end of the ground spring, wherein the U-shaped profile includes a first ridge and a second ridge, and wherein a reference line passing between the first ridge and the second ridge is parallel to an insertion direction of the data connector plug into the data connector receptacle. In this example or any other example, the data connector plug further comprises a plug-side retention magnet positioned such that, during insertion of the data connector plug into the data connector receptacle, the plug-side retention magnet is magnetically attracted to a receptacle-side retention magnet to cause a magnetic retention force that resists removal of the data connector plug from the data connector receptacle. In this example or any other example, the connector plug shell is sized and shaped to enclose a receptacle tab of the data connector receptacle, the receptacle tab including a lateral retention ramp. In this example or any other example, the data connector receptacle is a USB-C data connector receptacle, and wherein interaction between the ground spring and the lateral retention ramp causes a spring retention force that resists removal of the data connector plug from the data connector receptacle. In this example or any other example, insertion of the data connector plug into the data connector receptacle causes lateral deflection of the ground spring away from the lateral retention ramp. In this example or any other example, the spring retention force is greater than five newtons. In this example or any other example, the lateral retention ramp of the data connector receptacle is modified as compared to a standard USB-C data connector receptacle, such that the lateral retention ramp has a narrower ramp width, and wherein the lateral retention ramp passes between the first ridge and the second ridge of the U-shaped profile of the ground spring during insertion of the data connector plug into the data connector receptacle. In this example or any other example, a spring retention force caused by interaction between the ground spring and the receptacle tab is less than one newton. In this example or any other example, the data connector plug further comprises a plurality of plug-type connector contacts disposed within the connector plug shell, the plurality of plug-type connector contacts sized and shaped to interface with a corresponding plurality of receptacle-type connector contacts of the data connector receptacle.

In an example, an electronic device comprises: a data connector receptacle; and a receptacle tab disposed within the data connector receptacle, the receptacle tab including a lateral retention ramp, wherein the lateral retention ramp has a narrower ramp width as compared to a standard USB-C data connector receptacle; wherein, during insertion of a standard USB-C data connector plug into the data connector receptacle, interaction between the lateral retention ramp and a standard ground spring of the standard USB-C data connector plug causes a first spring retention force that resists removal of the standard USB-C data connector plug; and wherein, during insertion of a modified USB-C data connector plug having a modified ground spring with a U-shaped profile at a distal end of the modified ground spring, interaction between the lateral retention ramp and the modified ground spring causes a second spring retention force that is smaller than the first retention force. In this example or any other example, the electronic device further comprises a receptacle-side retention magnet positioned such that, during insertion of the modified USB-C data connector plug into the data connector receptacle, the receptacle-side retention magnet is magnetically attracted to a plug-side retention magnet to cause a magnetic retention force that resists removal of the modified USB-C data connector plug from the data connector receptacle. In this example or any other example, the first spring retention force is caused by lateral deflection of the standard ground spring due to contact between the lateral retention ramp and a surface of the standard ground spring. In this example or any other example, the first spring retention force is greater than five newtons. In this example or any other example, the U-shaped profile of the modified ground spring includes a first ridge and a second ridge, and wherein the lateral retention ramp of the receptacle tab passes between the first ridge and the second ridge during insertion of the modified USB-C data connector plug into the data connector receptacle. In this example or any other example, the second spring retention force caused by interaction between the modified ground spring and the receptacle tab is less than one newton. In this example or any other example, the electronic device further comprises a plurality of receptacle-type connector contacts disposed within the data connector receptacle, the plurality of receptacle-type connector contacts sized and shaped to interface with a corresponding first plurality of plug-type connector contacts of the standard USB-C data connector plug and a corresponding second plurality of plug-type connector contacts of the modified USB-C data connector plug.

In an example, a data connector plug comprises: a connector plug shell sized and shaped for insertion into a complementary data connector receptacle of an electronic device; a ground spring disposed within the connector plug shell, the ground spring having a U-shaped profile at a distal end of the ground spring, wherein the U-shaped profile includes a first ridge and a second ridge, and wherein a reference line passing between the first ridge and the second ridge is parallel to an insertion direction of the data connector plug into the data connector receptacle; and a plug-side retention magnet positioned such that, during insertion of the data connector plug into the data connector receptacle, the plug-side retention magnet is magnetically attracted to a receptacle-side retention magnet to cause a magnetic retention force that resists removal of the data connector plug from the data connector receptacle. In this example or any other example, the connector plug shell is sized and shaped to enclose a receptacle tab of the data connector receptacle, the receptacle tab including a lateral retention ramp. In this example or any other example, the data connector receptacle is a USB-C data connector receptacle, and wherein interaction between the ground spring and the lateral retention ramp causes a spring retention force that resists removal of the data connector plug from the data connector receptacle. In this example or any other example, the lateral retention ramp of the data connector receptacle is modified as compared to a standard USB-C data connector receptacle, such that the lateral retention ramp has a narrower ramp width, and wherein the lateral retention ramp passes between the first ridge and the second ridge of the U-shaped profile of the ground spring during insertion of the data connector plug into the data connector receptacle.

It will be understood that the configurations and/or approaches described herein are exemplary in nature, and that these specific embodiments or examples are not to be considered in a limiting sense, because numerous variations are possible. The subject matter of the present disclosure includes all novel and non-obvious combinations and sub-combinations of the various processes, systems and configurations, and other features, functions, acts, and/or properties disclosed herein, as well as any and all equivalents thereof.

1. A data connector plug, comprising:
a connector plug shell sized and shaped for insertion into a complementary data connector receptacle of an electronic device; and
a ground spring disposed within the connector plug shell, the ground spring having a U-shaped profile at a distal end of the ground spring, wherein the U-shaped profile includes a first ridge and a second ridge, and wherein a reference line passing between the first ridge and the second ridge is parallel to an insertion direction of the data connector plug into the data connector receptacle.

2. The data connector plug of claim 1, further comprising a plug-side retention magnet positioned such that, during insertion of the data connector plug into the data connector receptacle, the plug-side retention magnet is magnetically attracted to a receptacle-side retention magnet to cause a magnetic retention force that resists removal of the data connector plug from the data connector receptacle.

3. The data connector plug of claim 1, wherein the connector plug shell is sized and shaped to enclose a receptacle tab of the data connector receptacle, the receptacle tab including a lateral retention ramp.

4. The data connector plug of claim 3, wherein the data connector receptacle is a USB-C data connector receptacle, and wherein interaction between the ground spring and the lateral retention ramp causes a spring retention force that resists removal of the data connector plug from the data connector receptacle.

5. The data connector plug of claim 4, wherein insertion of the data connector plug into the data connector receptacle causes lateral deflection of the ground spring away from the lateral retention ramp.

6. The data connector plug of claim 4, wherein the spring retention force is greater than five newtons.

7. The data connector plug of claim 3, wherein the lateral retention ramp of the data connector receptacle is modified as compared to a standard USB-C data connector receptacle, such that the lateral retention ramp has a narrower ramp width, and wherein the lateral retention ramp passes between the first ridge and the second ridge of the U-shaped profile of the ground spring during insertion of the data connector plug into the data connector receptacle.

8. The data connector plug of claim 7, wherein a spring retention force caused by interaction between the ground spring and the receptacle tab is less than one newton.

9. The data connector plug of claim 1, further comprising a plurality of plug-type connector contacts disposed within the connector plug shell, the plurality of plug-type connector contacts sized and shaped to interface with a corresponding plurality of receptacle-type connector contacts of the data connector receptacle.

10. An electronic device, comprising:
a data connector receptacle; and
a receptacle tab disposed within the data connector receptacle, the receptacle tab including a lateral retention ramp, wherein the lateral retention ramp has a narrower ramp width as compared to a standard USB-C data connector receptacle;
wherein, during insertion of a standard USB-C data connector plug into the data connector receptacle, interaction between the lateral retention ramp and a standard ground spring of the standard USB-C data connector plug causes a first spring retention force that resists removal of the standard USB-C data connector plug; and
wherein, during insertion of a modified USB-C data connector plug having a modified ground spring with a U-shaped profile at a distal end of the modified ground spring, interaction between the lateral retention ramp and the modified ground spring causes a second spring retention force that is smaller than the first retention force.

11. The electronic device of claim 10, further comprising a receptacle-side retention magnet positioned such that, during insertion of the modified USB-C data connector plug into the data connector receptacle, the receptacle-side retention magnet is magnetically attracted to a plug-side retention magnet to cause a magnetic retention force that resists removal of the modified USB-C data connector plug from the data connector receptacle.

12. The electronic device of claim 10, wherein the first spring retention force is caused by lateral deflection of the standard ground spring due to contact between the lateral retention ramp and a surface of the standard ground spring.

13. The electronic device of claim 12, wherein the first spring retention force is greater than five newtons.

14. The electronic device of claim 10, wherein the U-shaped profile of the modified ground spring includes a first ridge and a second ridge, and wherein the lateral retention ramp of the receptacle tab passes between the first ridge and the second ridge during insertion of the modified USB-C data connector plug into the data connector receptacle.

15. The electronic device of claim 10, wherein the second spring retention force caused by interaction between the modified ground spring and the receptacle tab is less than one newton.

16. The electronic device of claim 10, further comprising a plurality of receptacle-type connector contacts disposed within the data connector receptacle, the plurality of receptacle-type connector contacts sized and shaped to interface with a corresponding first plurality of plug-type connector contacts of the standard USB-C data connector plug and a corresponding second plurality of plug-type connector contacts of the modified USB-C data connector plug.

17. A data connector plug, comprising:
a connector plug shell sized and shaped for insertion into a complementary data connector receptacle of an electronic device;
a ground spring disposed within the connector plug shell, the ground spring having a U-shaped profile at a distal end of the ground spring, wherein the U-shaped profile includes a first ridge and a second ridge, and wherein a reference line passing between the first ridge and the second ridge is parallel to an insertion direction of the data connector plug into the data connector receptacle; and
a plug-side retention magnet positioned such that, during insertion of the data connector plug into the data connector receptacle, the plug-side retention magnet is magnetically attracted to a receptacle-side retention magnet to cause a magnetic retention force that resists removal of the data connector plug from the data connector receptacle.

18. The data connector plug of claim 17, wherein the connector plug shell is sized and shaped to enclose a receptacle tab of the data connector receptacle, the receptacle tab including a lateral retention ramp.

19. The data connector plug of claim 18, wherein the data connector receptacle is a USB-C data connector receptacle, and wherein interaction between the ground spring and the lateral retention ramp causes a spring retention force that resists removal of the data connector plug from the data connector receptacle.

20. The data connector plug of claim 18, wherein the lateral retention ramp of the data connector receptacle is modified as compared to a standard USB-C data connector receptacle, such that the lateral retention ramp has a narrower ramp width, and wherein the lateral retention ramp passes between the first ridge and the second ridge of the U-shaped profile of the ground spring during insertion of the data connector plug into the data connector receptacle.
